(19) United States
(12) Patent Application Publication
(10) Pub. No.: US 2013/0073331 A1
(43) Pub. Date: Mar. 21, 2013

(54) UPDATING A CALENDAR OR TASK STATUS VIA TELEPHONY

(71) Applicant: Geoffrey Howard Nudd, San Francisco, CA (US)

(72) Inventor: Geoffrey Howard Nudd, San Francisco, CA (US)

(73) Assignee: ClearCare, Inc., San Francisco, CA (US)

(21) Appl. No.: 13/420,506

(22) Filed: Mar. 14, 2012

Related U.S. Application Data
(60) Provisional application No. 61/452,443, filed on Mar. 14, 2011.
(60) Provisional application No. 61/474,145, filed on Apr. 11, 2011.

(51) Int. Cl. G06Q 10/10

(52) U.S. Cl. 705/7.21

(57) ABSTRACT

A new approach to task management via digital calendaring, where non-event task calendar entries are configured with completion status indicators. The status indicators may be managed, modified and otherwise configured according to the preference of an administrator or user to express the status of a task in a meaningful way.

### RELATED APPLICATION

This application claims the benefit of U.S. Provisional Application No. 61/452,443, filed Mar. 14, 2011, the disclosure of which is incorporated by reference herein. This application also claims the benefit of U.S. Provisional Application No. 61/474,145, filed Apr. 11, 2011, the disclosure of which is incorporated by reference herein.

### BACKGROUND

Computer-enabled calendar systems date to the early days of software. In the 1990s and thereafter, a growing number of online calendar systems have been introduced that include operations for a user to, among other functions, create new events and tasks, schedule with other users, and send and receive reminders. Many of these calendars are now available online, such as that provided by Google Calendarz™, wherein they allow access across geographies and via any Internet-enabled terminal.

A problem with existing online calendar systems is in their management of “tasks”, that may be defined as an assignment of work to-be-completed with an assigned date on that the work is to be completed and/or started and/or in-progress, and at least one complete or incomplete state. As defined herein, tasks are a superset that contains “events” that are typically meetings or scheduled occurrences in that the work to-be-completed primarily or exclusively involves attendance or participation in the event itself (i.e. a meeting). An important differentiator between events and tasks that are not events, that are often referred to as “to do's” and that we shall call “nonevent tasks”, is that non-event tasks lend themselves to tracking via checklists, a well-known and remarkably effective and simple way to track outstanding and completed tasks, wherein it is generally not effective or useful to track events via checklists, for example, a checklist of outstanding and/or completed meetings.

A subtle but important oversight is that the existing online calendar systems such as Google Calendar, Yahoo Calendar and others have built rich functional capabilities for the management of events such as the ability to create recurring series of events, for example, a meeting that occurs every Monday at 10:00AM, or the ability to send invitations to a variety of attendees, but have not introduced similar capabilities for the management of non-event tasks. Conversely, existing calendar systems have introduced functionality such as checklists for non-event tasks that have not been created for events. This introduces a significant shortcoming, particularly in the creation of work management systems that provide the ease of use and flexibility of a calendar interface with the work tracking capabilities of checklists. In particular, the inventor finds that it is an important shortcoming of the existing art that no existing online calendar systems enable the ability to create recurring non-event tasks in a computer-enabled system with a checklist interface that enables a user to mark the status of a task, including but not limited to marking the status of a task as complete.

Moreover, today, computer-enabled online calendar systems are only accessible via a computer terminal with a visual interface such as a computer monitor and require some form of Internet connection. As there are today no means of creating recurring non-event tasks in a calendar system and managing their completion via a checklist interface, it follows that there are no means of interfacing with said new inventive systems via any means. It would be advantageous if the aforementioned problem was solved and moreover if the functionality could be accessible by a remote computer terminal connected to the Internet. Moreover, for situations in that a remote computer terminal connected to the Internet is difficult or cost-prohibitive, it would be advantageous if there were other means to interface with said inventive online calendar functionality. The invention described herein will address these problems.

While there exists simple clock-in and clock-out functionality via telephony relative to expected work times and/or times of worker's shift, such as that provided by Santrax (www.santrax.com), there is presently no way to access such calendar systems with task-level specificity via telephony. Solutions such as Santrax have existed for many years without solving the problem of task-level specificity, nor have they solved the aforementioned problems with the treatment of non-event tasks. These are critical oversights that significantly reduce the usefulness of the known art.

By way of example and without limitation, in the in-home health care industry, solutions like Santrax are used to track clock-in and clock-out times relative to shifts using telephony to update the clock-in or clock-out status of a remote caregiver. While this system enables specification of work shifts and remote updates of clock-in and clock-out status, the detailed tasks that comprise a care plan cannot be updated via the remote telephony system. There are complex challenges associated with enabling such a system, such as text-to-voice automated translation of tasks in a care plan, that heretofore have not been addressed.

Additionally, again considering without limitation the present example of in-home care agency management software, what is desired is a flexible, easy-to-use calendar system that enables the specification of non-event tasks with features like recurrence of an event at specific times during specific days of the week, weeks in the month, etc. and the ability to update status in an easy-to-use electronic checklist. To have such a system would provide flexibility and ease-of-use that today for the service of the in-home care agency industry.

These shortcomings with the existing art lead to many problems including very limited transparency and control over the care plan to stakeholders such as in-home care managers, healthcare providers, and the family members of a patient or client. Moreover, in the example of the in-home care industry, these shortcomings are typically addressed via mechanisms like paper care journals that reside in the home of the patient and that are periodically updated by caregivers. The paper care journals are often overlooked by caregivers and the in-home care managers and the families of the patients have no visibility to the care provided and the tasks performed. This industry example illustrates the very significant and important problems with the existing art, and the quality of care can be significantly improved by solving these problems. The invention addresses these problems in an elegant manner to provide work management systems with unprecedented ease of use, flexibility, and cost-effective accessibility in a plurality of locations that was never before possible.

### BRIEF DESCRIPTION OF THE DRAWINGS

Various embodiments of the invention are illustrated by way of example, and not by way of limitation, in the figures of the accompanying drawing and in that like reference numerals refer to similar elements and in that:

FIG. 1 is a wireframe diagram that illustrates an interface of a web-based portal for a work management system that provides tracking and management of work, a photo storage service that enables the automatic display of photos that are uploaded via said web-based portal to a digital picture frame, the creation and management of nonevent tasks, and the updating of the status of non-event tasks via a checklist interface and/or telephony.

FIG. 2 is a wireframe diagram that illustrates the task input calendar interface of a web-based portal for a work management system that provides tracking and management of work, a photo storage service that enables the automatic display of photos that are uploaded via said web-based portal to a digital picture frame, the creation and management of non-event tasks, and updating of the status of non-event tasks via a checklist interface and/or telephony.

FIG. 3 is a wireframe diagram that illustrates a task details portion of a task input calendar interface of a web-based portal for a work management system that provides tracking and management of work, a photo storage service that enables the automatic display of photos that are uploaded via said web-based portal to a digital picture frame, the creation and management of non-event tasks, and the updating of the status of nonevent tasks via a checklist interface and/or telephony.

FIG. 4 and FIG. 5 are wireframe diagrams that illustrate interfaces for caregivers and their patients that are part of the healthcare information system described herein, and that are preferably displayed on a touch screen tablet (by way of example, an Apple iPad) that is used by a caregiver to manage and document care tasks, and that also functions as a digital picture frame when not in use by the caregiver or other users.

FIG. 6 is a flow diagram that illustrates a process by that the status of specific task information is updated via telephony using computer-enabled text-to-voice conversion.

FIG. 7 is a block diagram in accordance with the present invention that illustrates the communication of entities via Internet connections for the transmission of a variety of information.

### DETAILED DESCRIPTION

The invention is directed to a novel approach to managing work tasks. In one embodiment, a distributed work management system configured to manage work schedules of personnel and tasks assigned to particular personnel or clients is provided that tracks tasks, their status, time schedules associated with the tasks, non-event task management, and may include other features for managing a work environment. In one example, a computer implemented method for managing tasks in a work management system is provided that provides a digital calendar system configured to receive calendar entries, is configured to receive data to establish non-event tasks for use in the digital calendar, and to also receive status updates to the non-event task. A non-event task has attributes of completion status that may or may not be associated with the scheduling of the task itself, and it may have other attributes that are not typically associated with event type tasks such as for example meeting times, birthdays, holidays, and other events that may or may not have completion statuses or other similar attributes. A task or tasks may also be associated with a status indicator or indicators that is/are specific to that task or tasks. The status indicator may be of different forms or configurations, including a check list entry from a user, a status code that relates to predetermined status definitions, or other types of indicators.

In some work situations, there may be a complicated status identifier that is required in order to adequately explain the status of the task, or reasons why the task was not completed, was deferred, was overruled by the work responsible for the task or by a client who is the recipient of the task, or is otherwise not possible. Thus, another status indicator may include comments from a user related to the status of the task. The comments may be in addition to another task identifier, for example a predetermined or predefined status identifier may indicate that the task was simply “not completed”, and the system may allow for comments associated with the task that explains why it was not completed, for example “Task was not completed because the client was not feeling well and wanted to postpone.” A status indicator may be associated with one or more particular tasks, or it may related to all tasks, or various status indicators may relate to one or more tasks. Generally, what is provided is a flexible approach to managing tasks in a calendar including their completion status, scheduled times according to date and/or time, and other information related to the tasks. The tasks may be rescheduled, the status may change over time and through rescheduling, they may be renewed, copied, or otherwise reconfigured in the system.

The status updates may be received in the system by a number of sources or paths, including telephony updates to the task related data used in the digital calendar. Thus, a user may update a task via a phone, including a mobile device or a land line phone, were updates are sent from remote locations. Voice recordings may also be included together with the status updates, and may also be converted to text and uploaded digitally on the system for administrators or other authorized persons or entities to read. A system may also receive updates to the task related data used in the digital calendar from a web-based portal of a work management system, from a dedicated work station connected to a local area network (LAN), other network system, or internet connection. Thus, the system may be further flexible in allowing remote access by users desiring to more promptly and timely update the status of tasks. a. In another embodiment, a status indicator may be a calendar entry that is associated with a particular task and that is copied from another calendar entry. The status entry may be an instance in the work management system that includes a checklist that is copied from another instance of a status in the work management system. The status entry may alternatively be an instance in the work management system associated with a scheduled item that includes a checklist that is copied from another instance of a status in the work management system. Other configurations are possible given this description, and those skilled in the art will understand that other combinations and permutations of the features and benefits described herein may provide unique benefits to many even different systems without limiting the invention, which is defined by the appended claims and their equivalents, and also possible future submitted claims and their equivalents.

According to one example, an apparatus and computer-enabled system implemented by software is provided for enabling the creation of nonevent tasks in a calendar system wherein the entry of a single non-event task can be made recurring on a daily, weekly, or monthly basis according to parameters set by the user; and/or wherein the non-event task may be assigned to one or more persons or groups of persons for completion; and/or wherein the completion status of one or more non-event tasks may be updated via a computer-enabled terminal connected to the Internet; and/or wherein one or more users at remote locations may view the updated completion status of the one or more non-event tasks; and/or wherein an exception state may be noted relative to the completion of one or more non-event tasks and a reason provided by the assigned person(s); and/or wherein the completion status of the one or more non-event tasks is managed by a checklist interface.

Calendars may be interfaced with via a telephony system and/or via a computer connected to the Internet wherein the telephony system enables the person(s) assigned to a non-event task to update the completion status of the non-event task. In one embodiment, the computer-enabled system uses automated text to-voice technology such as that enabled by commercial providers such as Twilio (www.twilio.com) accessed via an application programming interfaced (API) in conjunction with software code known by those skilled in the art to read instructions or other parameters of one or more non-event tasks to the person(s) assigned. In another embodiment, the computer-enabled system accepts input via telephone from the person(s) assigned by that the person(s) updates the status of the non-event task. By way of example, by pressing the number “one” on the telephone after the computer-enabled system reads the instructions and/or title for the non-event task, the person(s) assigned marks the task complete. In another embodiment, if the person(s) assigned notes an exception to the expected status of the non-event task such as updating the status as “incomplete,” then the person may communicate a voice message that is associated with the task and/or group of tasks that communicates additional information that may include, by way of example, the reason that the non-event task was not completed.

In another embodiment, the voice message is stored in a system accessible via the Internet by that the status of one or more tasks (the “checklist”) may be viewed by one or more users. In another embodiment, a transcript of the voice message is recorded and displayed next to the relevant non-event task or group of tasks. In another embodiment, the transcript of the voice message is created via automated computer enabled voice-to-text translation as enabled by commercial providers such as Twilio, accessed via API in conjunction with other software code, the implementation of that can be performed by those skilled in the art.

In another embodiment, the aforementioned telephony-accessible calendar system is used as part of a work management system for the management of a remote workforce.

In another embodiment, the aforementioned telephony accessible calendar system is used as part of a work management system for in-home care agencies enabling the management of caregivers working remotely in the homes of patients and/or clients to provide care.

In another embodiment, the telephony system verifies the location of the remote worker at the time the status of a non-event task is recorded by comparing the caller ID of the telephone from that the remote worker is calling to a database of known telephone numbers and locations.

In another embodiment, the work management system automatically generates an alert that is communicated to one or more users in the event that a non-event task is not completed as expected per parameters designated by one or more users.

In the following description, for the purposes of explanation, specific details are set forth in order to provide a thorough understanding of the invention. However, it will be apparent that the invention may be practiced without these specific details. In other instances, well-known structures and devices are depicted in block diagram form in order to avoid unnecessarily obscuring the invention.

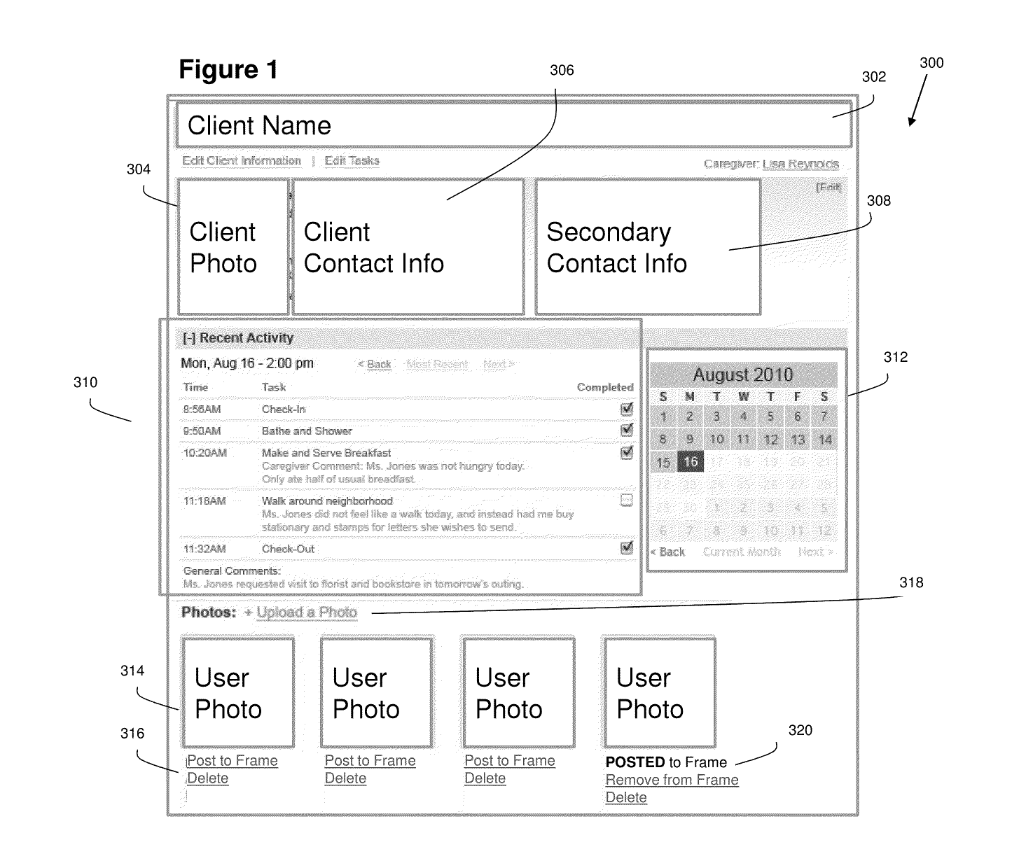

FIG. 1 is a wireframe diagram that illustrates an interface of a web-based portal for a work management system that provides tracking and management of work, a photo storage service that enables the automatic display of photos that are uploaded via said web-based portal to a digital picture frame, the creation and management of nonevent tasks, and the updating of the status of non-event tasks via a checklist interface accessible by a computer connectable to the Internet, a mobile tablet connectable to the Internet, and/or telephony.

In one embodiment, a touch screen tablet functioning as a digital picture frame and connected to the Internet, such as an Apple iPad, functions as a device by that one or more work providers manages and documents tasks at the client point-of-service.

Element 302 illustrates a field by that identifying information of a client is displayed. Element 304 illustrates a field by that a photo of the client is displayed. Elements 306 and 308 illustrate fields by that contact information of the client is displayed. The reader may imagine that a variety of user or user group profile information may be displayed.

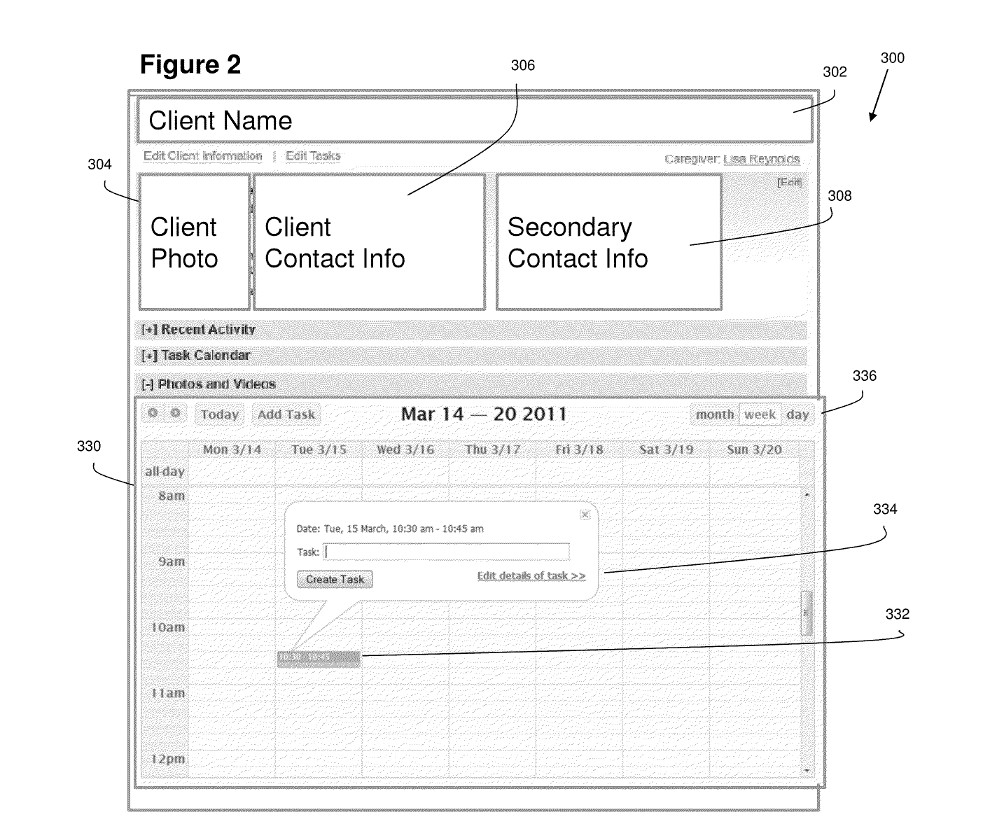

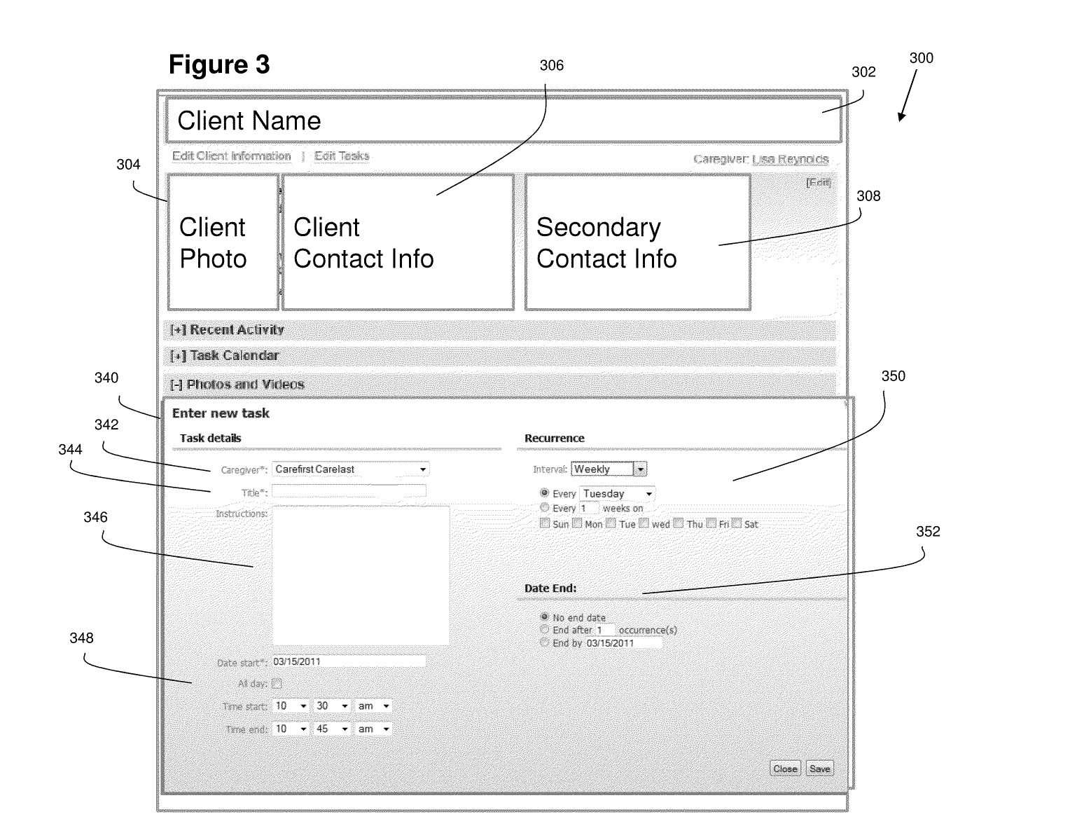

Elements 310 and 312 are examples of an integrated work management system that performs a variety of functions that may include but are not limited to: (1) tracking the completion and status of non-event tasks, (2) enabling work providers to provide input to said work management system via a separate interface (see FIG. 2 and FIG. 3) and/or via telephony as will be described, and/or (3) enables the client or family of the client to view tasks that have been completed by a work provider.

In one embodiment, any user of the web portal 300 must be authenticated before being able to view the web portal 300 in order to protect the confidential and private information of the client. Means of authentication are well-known to those skilled in the art and include but are not limited to password protection and/or use of a personal identification number (PIN).

Element 310 illustrates a list of non-event tasks (“checklist”). In one embodiment, the list provides status information for each task that may include but is not limited to a variety of states such as to-be-completed, complete, incomplete, or exception. As shown in the present example, the task list 310 includes a variety of information for each task, including but not limited to the time at that a work provider completed a task and/or made an input relative to the task, a description of the task, comments submitted by the work provider, and whether or not the task was completed. Element 312 illustrates a calendar input interface that when a day is clicked queries the set of non-event tasks related to that day, including completed and incomplete tasks, and tasks that are planned in the future, and In one embodiment displays said tasks in a task list 310.

In one embodiment, a work provider logs-in to the system from the point-of-service of the client, sees the non-event tasks that are to be completed, and marks tasks as complete and/or incomplete and/or enters comments as the work provider works towards the completion of tasks. In one embodiment, said comments and completion inputs from the work provider are transmitted via the Internet to the work management system, and the completion information about the tasks and the comments are shown in element 310 when one of a variety of authorized users, such as a manager or administrator, the work provider, the client, or the family or colleagues of the client view the web portal 300. Thus, multiple benefits are possible including transparency of work performed to the aforementioned parties.

Element 318 illustrates a link to “Upload a Photo” that directs to a web-enabled interface that features an input field, a “Browse” button to find photo files on a local system, and an “Upload” button. Via these buttons and associated features, a photo file may be selected and uploaded to the work management system and thereby displayed in element 314 and stored. Systems and methods for uploading a photo file over the Internet are well known to those skilled in the art. The photo 314 may thereby be subsequently displayed by the system serving as a point of service input device for work providers, that thus in a preferred embodiment also serves as a digital picture frame.

Via this interface, family members, friends, or other persons authorized by the client and/or work provider are able to both monitor work and upload photos 314 for display on the digital picture frame that displays the photos 314 when said frame is not in use by the work provider for the provision and tracking of work (see FIG. 2 and FIG. 3). Element 316 is a pair of hyperlinks to “Post to Frame” or “Delete” that respectively trigger functions to designate the photo 314 for download by the digital picture frame, or to delete the photo 314 from the work management system. The links illustrated in element 316 are displayed when a photo 314 is displayed on the work management system, but that have not been designated for download by the digital picture frame.

Element 320 illustrates the text, hyperlinks and features that are preferably displayed and made active, respectively, when a photo 314 has been designated for display in the digital picture frame. The words “POSTED to Frame” indicate that the photo 314 has been designated for display in the digital picture frame. The “Remove from Frame” hyperlink enables the user to remove the designation that the photo 314 is to be displayed in the digital picture frame. The “Delete” hyperlink in element 316 enables the user to delete the photo 314 entirely from the work management system, and thereby to also delete the photo 314 from the digital picture frame.

FIG. 2 is a wireframe diagram that illustrates the task input calendar interface 330 of a web-based portal 300 for a work management system that provides tracking, management and assignment of work, a photo storage service that enables the automatic display of photos that are uploaded via said web-based portal to a digital picture frame, the creation and management of non-event tasks, and updating of the status of non-event tasks via a checklist interface and/or telephony.

In one embodiment, the task input calendar interface 330 is readily accessible and adjacent to the client-specific interface with elements 302, 304, 306 and/or 308, and/or the interface related to task status 310, and/or the interface related to digital photo functionality containing elements 314, 316, 318 and/or 320.

In task input calendar interface 330, a user may create a new work task by clicking any time on the calendar and/or by clicking an “Add Task” button. In one embodiment, the rapid addition of tasks is enabled by simply clicking on a time in the calendar 332, typing the name and/or instructions of the Task, and clicking “return.” In another embodiment, the completion status of the non-event task can be tracked via the interface described in element 310 based on input at the point-of-service from the work provider.

If the task has additional parameters including but not limited to detailed instructions or recurrence, the user may click “Edit details of the task” in the interface 334 to provide the additional parameters. By way of example and without limitation, see FIG. 3 for an illustrative list of additional parameters that may be specified.

In one embodiment, various views of the calendar may be used by clicking inputs 336 including but not limited to a view of the current day, another day, a week, or a month. As such, a level of calendar granularity convenient to the user may be viewed.

In another embodiment, the calendar is implemented via Ajax, a group of interrelated web development methods used on the client-side to create interactive web applications.

FIG. 3 is a wireframe diagram that illustrates a task details portion 340 of a task input calendar interface of a web-based portal 300 for a work management system that provides tracking and management of work, a photo storage service that enables the automatic display of photos that are uploaded via said web-based portal to a digital picture frame, the creation and management of non-event tasks, and the updating of the status of non-event tasks via a checklist interface and/or telephony.

In one embodiment, the task details interface 340 contains an input to assign the work provider 342. For illustrative purposes and by way of example, said input 342 may be to assign a work provider of the type “caregiver” wherein the work management system would be an in-home care work management system. The aforementioned is provided by way of example, and the invention has applicability to any variety of work types and work providers. In another embodiment, the name of the work provider is assigned a default value based on the primary work provider assigned to the particular client, but wherein another work provider may be designated specifically for the task.

In one embodiment, an input 344 captures the title and/or high-level instructions for the task. In another embodiment, an input 346 enables input of detailed instructions for the task. In another embodiment, an input 348 enables input of the start date, start time and end time of the task and/or the designation of the task as an “all day” task.

In another embodiment, the user may specify recurrence of the task via a collection of inputs in interface areas 350 and 352. The recurrence may be daily with a variety of parameters including but not limited to every day, every “x” number of days, every weekday, etc.; the recurrence may be weekly or every “y” weeks with a variety of parameters including but not limited to every week on one or more specific days of the week, or monthly on every “z” of every month, every “z” day (i.e. Thursday) of every month, etc. Systems for establishing recurrence for an event or meeting are well-known to those skilled in the art; however these systems for creating recurrence have not been applied to the creation of non-event tasks in an online calendar system.

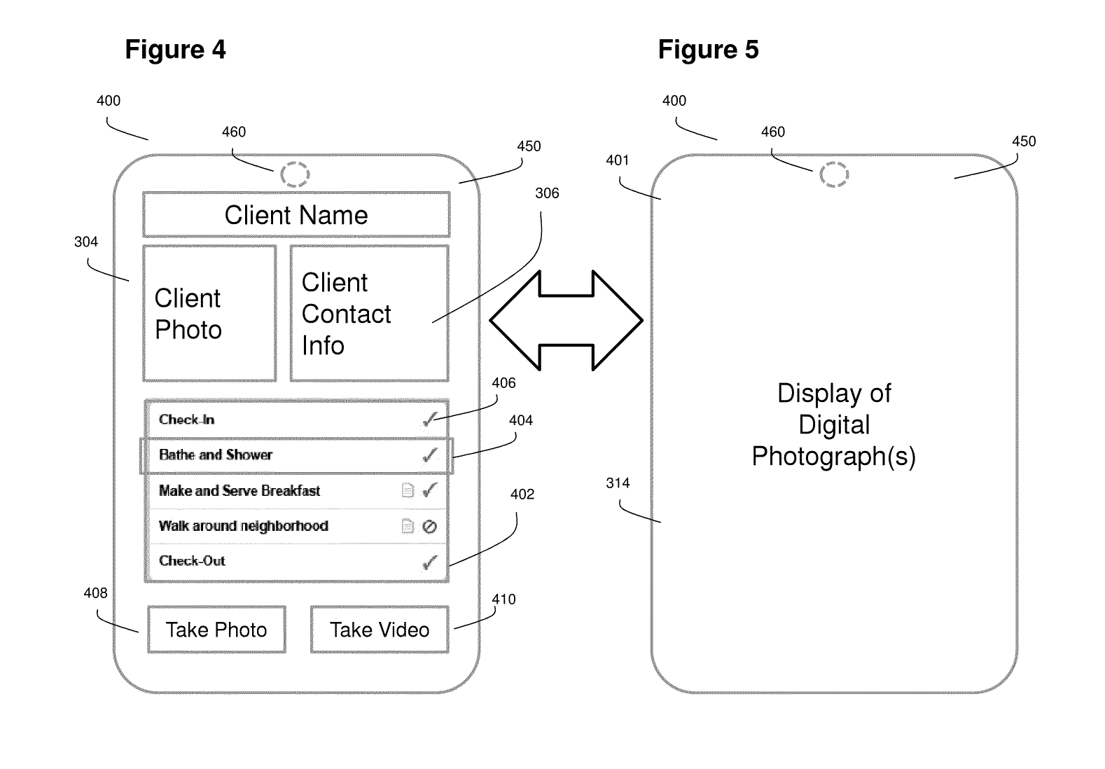

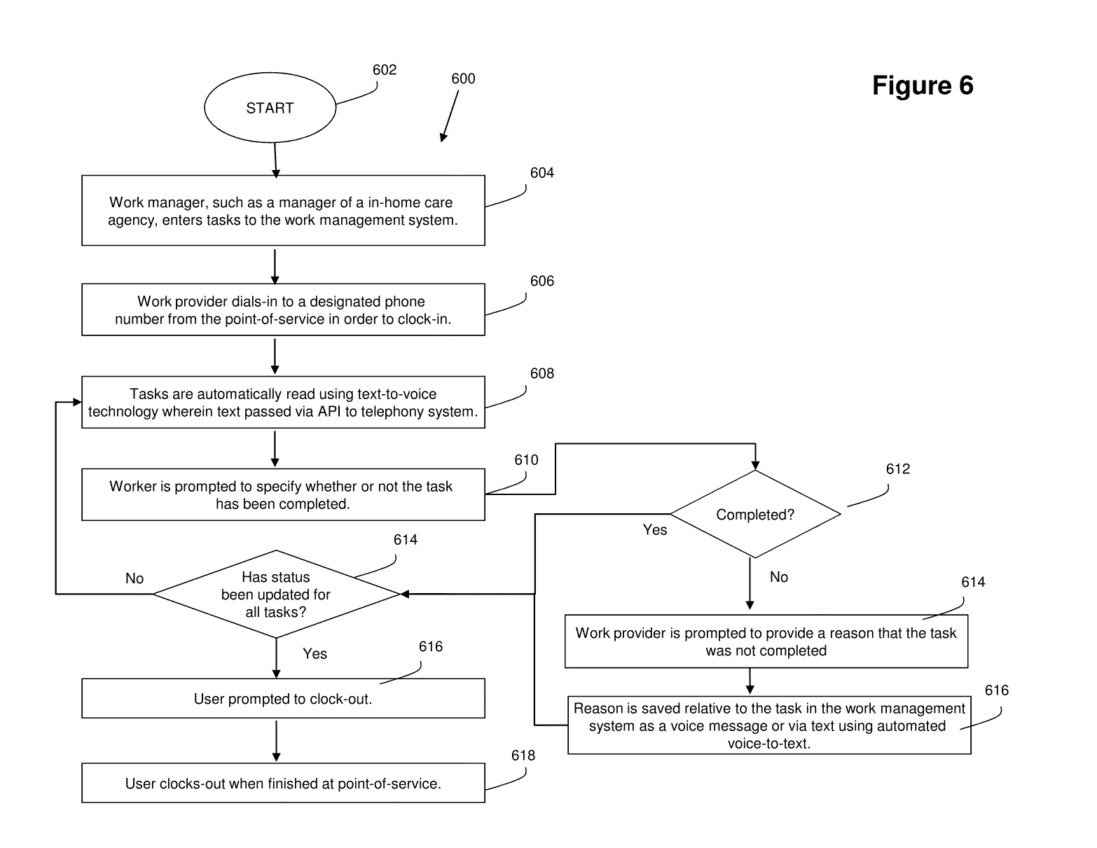

In another embodiment provides the ability to specify recurring non-event tasks in the calendar interfaces 330 and 340 wherein the completion status of the non-event tasks may be tracked via a checklist 310. Another example provides the ability to modify the status of a non-event task remotely via an Internet-connected computer terminal as shown in FIGS. 4 and 5, or via telephony as described in FIG. 6.

While the wireframes shown in FIGS. 1, 2 and 3 illustrate particular interface layouts for a work management system, one skilled in the art can anticipate many other specific variations. Additionally, many of the elements such as 302, 304, 306, 308, 314, 316, 318, 320 and others may be generalized for use of the disclosed invention in the context of a social networking website, photo sharing website, or other system.

A specific case of the disclosed work management system is the application of said system for in-home care agencies wherein a multitude of clients receives in-home care and the work provider is a caregiver. The present work management system invention is particularly valuable in improving the lifestyle and happiness of elderly patients receiving in-home care from a caregiver by enabling the adult children and family of elderly patients to keep track of the provision of care and also to share said photos with the elderly patients. For an in-home care agency that manages care plans for a number of clients and that manages a number of caregivers, the system provides real-time transparency to care and a simple, easy-to-use interface for scheduling care.

FIG. 4 and FIG. 5 are wireframe diagrams that illustrate interfaces for caregivers and their patients or clients that are a specific instance of the aforementioned work management system described herein, and that are preferably displayed on an Internet connectable touch screen tablet (ex. Apple iPad) that is used by a caregiver to manage and document care tasks, and that also functions as a digital picture frame when not in use by the caregiver or other users. It may be appreciated by those skilled in the art that features described herein as accruing to the benefit of caregivers could be generalized to work providers of other types and accrue to the benefit of any number of varieties of remote work providers, and similarly the care management features and benefits described can accrue to the benefit of any variety of organizations involved in the management of remote work providers.

Computer system 400 includes an interface 450, and illustrates another example where a said computer system 400 is a touch screen computer tablet in that inputs to the computer system may be made by the user by touching the display screen interface 450, and that includes a built-in digital camera 460 that can take digital photographs that in turn can be stored, manipulated and transmitted by the computer system 400. Such computer systems 400 are well known and are widely distributed and sold, including by way of example the Apple iPad. Element 400 illustrates the touch screen tablet in a mode in that the interface 450 is configured to be used by a caregiver as part of a work management system to manage and track the completion of care tasks.

FIG. 5 illustrates the touch screen tablet computer system 400 in a mode in that 20 the interface 450 is configured for the display of photos 314 in accordance with the system's 400 additional capability as a digital picture frame. Element 402 is a list of tasks that are to be completed by the caregiver. In one embodiment, the caregiver may click or otherwise input to any individual task 404 listed to changes its status, by way of example, from “Incomplete” to “Complete.” In another embodiment, the caregiver may double-click or otherwise input to any individual task listed 404 to write one or more comments relative to the task 404. In one embodiment, each task 404 shows a completion indicator 406 that indicates the status of the task 404, and/or an indication 406 that comments have been made about the task 404, and/or an indication 406 there are detailed notes about the task 404 that may be stored on the work management system, and wherein the absence of such a displayed indicator 406 can also indicate the status of a task 404. The user may appreciate that a variety of information may be provided by such an indicator 406 for each task 404.

In one embodiment, after the caregiver changes the status of one or more tasks 404 on the task list 402, the changes in the status of the one or more tasks are transmitted to the work management system wherein the updated status of the tasks 404 can be displayed on the list of tasks 310 in the web portal interface illustrated in FIG. 1.

Element 408 illustrates a button that is displayed on the interface 450 that when clicked, in one embodiment, configures the system 400 and camera 460 to take a digital photograph. In one embodiment, the caregiver authenticates his or her identity upon checking-in to a client site and/or prior to viewing tasks and/or changing the status of any tasks, such that said photo may be automatically uploaded to the work management system without subsequent authentication by the caregiver.

In another embodiment upon clicking the button 408, the caregiver is prompted by software running on the system 400 to confirm with a “yes” or “no” response whether or not the client has given explicit permission to the caregiver for such a photograph to be taken. In another embodiment, the caregiver is prompted via the interface to physically hand the system 400 to the client wherein the client is instructed to authenticate his or her identity with a password or other means in order to enable a photograph to be taken and uploaded to the work management system. The prompts described herein assist with compliance with laws that protect the privacy and confidential health information of clients.

In another embodiment, any photograph that is taken by the system 400 when used in conjunction with the work management system, for example, by clicking the button 408, is restricted such that it is not stored on the system 400 after the caregiver logs out of the work management system, and/or such that said photograph may only be stored permanently if it is transmitted over the Internet to the work management system, and/or stored on said work management system in a secure, remote database, wherein the photo is subsequently deleted from the device 400 after the caregiver logs-out of the present session with the device 400. Thus, photographs taken by the caregiver of the client are restricted in circulation such that the one or more photographs can only be viewed via secure work management interfaces such as illustrated in FIG. 1.

Element 410 illustrates a button that is displayed on the interface 450 that when clicked, In one embodiment, configures the system 400 and camera 460 to take a digital video. The aforementioned functions and features for taking a photo by pressing the button 408 parallel those functions and features for taking a video by pressing the button 410, with the difference that the media file is a digital video file instead of a digital photo file in the case that button 410 is pressed.

FIG. 5 illustrates the touch screen tablet computer system 400 in a mode in that the interface 450 is configured to display one or more photos 314 in accordance with the system's 400 additional capability as a digital picture frame. This mode may be activated according to settings configured by the client, by the caregiver, by a caregiver administrator, or by other users and/or administrators of the integrated work management system, and/or may be preset in software stored on the system 400, or by other means that are understood to those skilled in the art.

FIG. 6 is a flow diagram that illustrates the use of telephony instead of a touch 15 screen tablet or other remote Internet interface as means to input updates to tasks in the work management system.

In the aforementioned scenario in that the work management system is used for the management of an in-home care agency, there is sometimes the problem that the remote terminals by that task information is updated are too expensive to be afforded by the client or by the in-home care agency. Moreover, many clients do not have Internet connectivity in their homes making it difficult and/or expensive to transmit updates of task status to the work management system. This problem, while acute in the in-home care agency industry, is also common to other industries that are dependent on a remote workforce that does not have readily available access to a computer terminal with connection hardware.

In the late 2000s, an increasing number of telephony services providers emerged such as Twilio (www.twilio.com) and Tropos (vvww.tropos.com) that provide application programming interfaces (APIs) that are readily usable by those skilled in the art of software programming to build computer-enabled applications that use telephony, including voice recognition, voice-to-text automated transcription, text-to voice technologies, and text messaging, to serve a variety of purposes.

The present invention solves this problem via the use of telephony and the new commercially available telephony services. In one embodiment, the aforementioned calendar inventions may be interfaced with via a telephony system and/or via a computer connected to the Internet wherein the telephony system enables the work provider(s) assigned to a non-event task to update the completion status of the non-event task.

In one embodiment, the computer-enabled system uses automated text-to-voice technology such as that enabled by commercial providers such as Twilio (www.twilio.com) accessible via an application programming interfaced (API) in conjunction with software code known by those skilled in the art to read instructions or other parameters of one or more non-event tasks to the person(s) assigned.

In another embodiment, the computer-enabled system accepts input via telephone from the person(s) assigned by that the person(s) updates the status of the non-event task. By way of example, by pressing the number “one” on the telephone after the computer-enabled system reads the instructions and/or title for the non-event task, the person(s) assigned inputs a status update to mark the task as complete in the work management system.

In another embodiment, if the person(s) assigned notes an exception to the expected status of the non-event task such as updating the status as “incomplete,” then the person may communicate a voice message that is associated with the task and/or group of tasks that communicates additional information that may include, by way of example, the reason that the non-event task was not completed.

In another embodiment, the voice message is stored in a system accessible via the Internet by that the status of one or more tasks (the “checklist”) may be viewed by one or more users. In another embodiment, a transcript of the voice message is recorded and displayed next to the relevant non-event task or group of tasks. In another embodiment, the transcript of the voice message is created via automated computer-enabled voice-to-text translation as enabled by commercial providers such as Twilio accessibly via API in conjunction with other software code, the implementation of that is known to those skilled in the art. By way of example and without limitation, the voice message or its transcription may be displayed in a checklist on a web portal 300 such as illustrated in element 310 of FIG. 1.

Referring now to FIG. 6, starting at 602, the work manager enters tasks to the work management system in step 604. In one embodiment, the tasks are entered to the work management system via a calendar interface 330 in a web portal 300 with the additional features of being able to specify recurrence via inputs 350 and 352. In another embodiment, the tasks are entered relative to a specific client and the client contact information 306 includes the location at that the service is to be provided and the telephone number of the client.

In step 606, the work provider dials-in to a designated phone number from the point-of-service in order to clock-in. In one embodiment, the work management system compares the caller ID of the telephone from that the work provider is calling to the contact information 306 of the client to verify that the work provider is at the proper location.

In step 608, tasks are read to the work provider sequentially using text-to-voice technology by passing text information related to the task such as the desired start time, the desired end time, the title or high-level instructions, and/or detailed instructions to a telephony service provider from the work management system via API. Telephony service providers such as Twilio (www.twilio.com) and related APIs are well-known to those skilled in the art. Thus, the work provider is prompted with the task(s) to be performed.

In one embodiment, all of the tasks to be performed within a specific period of time or shift are automatically read to the work provider in the first reading after the clock-in step 608 wherein there are no interruptions for prompts requesting completion status so that the work provider can be informed of the tasks to be performed, and wherein in subsequent readings, following the reading of each task there is a prompt in step 610 to the work provider to update the status of each individual task. In another embodiment, there is no such initial “read through” of tasks. Instead, after clock-in in step 606, the tasks are read one at a time in step 608 and after each task is read, the work provider is prompted to answer whether or not the task has been completed in step 610. The work provider can respond to the prompts using means well-known to those skilled in the art such as by pressing a digit on the phone or responding verbally. The commercially available telephony service interprets the input from the work provider in step 612 per rules specified in software code as is known to those skilled in the art, and if the task has been marked as complete, in step 614, a determination is made as to whether or not there are additional tasks for that status has not been updated.

If there are additional tasks for that status must be updated, then the process repeats in step 608 as the next task is read. If status has been updated for all tasks as determined in step 614, then the process proceeds to step 616 wherein the work provider is prompted to clock-out. If the work provider has no further work to do at the point-of service, then in step 618 the work provider clocks-out.

Returning now to the task status update process, in step 612, if the work provider responds that the task has not been completed, In one embodiment, in step 614 the work provider is prompted to record a reason that the task was not completed. In another embodiment, in step 616, the reason provided in 614 is saved in the work management system as a voice message file via means well-known to those skilled in the art and enabled by telephony service providers such as Twilio, or is automatically transcribed to text using voice-to-text technologies provided by telephony service providers such as Twilio. After recording the reason, the process proceeds to step 614 wherein it is determined whether or not the status has been updated for all Tasks.

In another embodiment, the recording of the reason, whether in a voice message or in transcription, is accessible via web portal 300, 10 preferably in a checklist interface 310.

In one embodiment, the work management system compares the caller ID of the telephone from that the work provider is calling to the contact information 306 of the client to verify that the work provider is at the proper location during the point in time at that status for each task is updated. In another embodiment, the work provider can hang up the phone at any point and resume the process at the step at that the work provider last left-off by calling the telephony service phone number again.

In one embodiment, as the status of tasks is updated via the telephony system, the updated status can be viewed via the web portal 20 300 via interface 310 as shown and described relative to FIG. 3. In another embodiment, alerts are provided via the web portal 300, via text messaging, via outbound calling as enabled via the telephony service, or other means known to those skilled in the art to the work manager, the work provider, persons associated with the client, or other stakeholders in the event that a clock-in is missed or if a task is not completed, completed, and/or marked with a status that is designated to trigger an alert. Thus, the telephony service in the work management system enables a variety of stakeholders to have real-time visibility of highly specific tasks without requiring a costly remote computer terminal such as, by way of example, a mobile computing tablet 400.

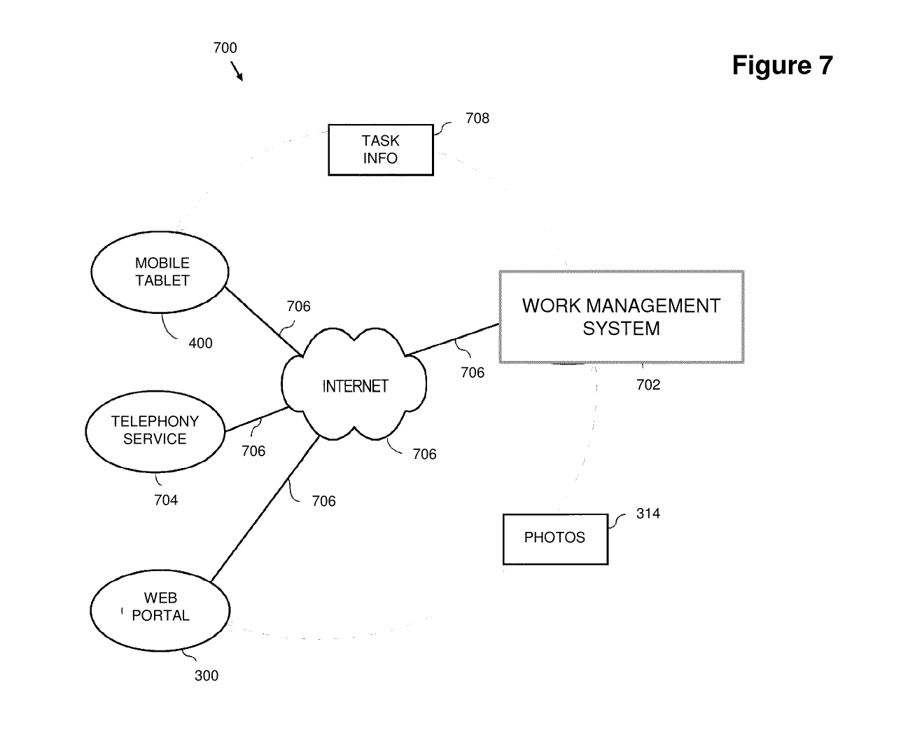

FIG. 7 is a block diagram 700 in accordance with the present invention that illustrates the communication of entities via Internet connections 706 for the transmission of a variety of information including but not limited to digital photographs 314 for display on a digital picture frame 400 and/or work management system 702 accessible via a web portal 300, task information 708, possibly including but not limited to updates to the completion status, telephony service 704 by that task information 708 and other information may be sent and received in order to enable updates to the work management system 702 accessible via the web portal 300, and the mobile tablet 400 also functioning, In one embodiment, as a digital picture frame as well as additional means by that task information 708 and other information may be sent and received to and from the work management system 702 accessible via the web portal 300.

In one embodiment, via a web portal 300, task information 708 may be input to the work management system 702, to be provided to a work provider via a mobile tablet 400 or via telephony service 704. The work management system 702 comprises a database, computer-enabled means to interpret software code, and computer-enabled means to communicate between various devices and interfaces accessing the work management system 702 including the mobile tablet 400, the telephony service 704, and the web portal 300. In another embodiment, the work management system includes computer and software-enabled means for displaying photos 314 and other media on the mobile tablet 400 when the mobile tablet 400 is not in use by a work provider to inform the completion of assigned tasks, to update task status, or to otherwise inform and manage the work plan.

Considering now a specific application by way of example and without limitation to the aforementioned, an in-home care agency managing a multitude of patients or clients and a multitude of caregivers realizes a great number of benefits via usage of the aforementioned inventions. Today, many in-home care agencies use paper care journals at the point-of-care to manage care and record updates as to the completion of tasks. Unfortunately, the use of paper care journals makes it impossible for in-home care agency managers and family and adult children of elderly clients to closely observe the care provided.

The mobile tablet interfaces eliminate the need for paper care journals and enable real-time visibility to the point-of-care for in-home care agency managers and for the family of patients and clients. This significantly reduces costs and improves the quality of care.

For situations in that a mobile interface cannot be afforded, the telephony service provides a low-cost means leveraging patients and/or client's existing phone systems to achieve the same benefits with a level of granular visibility to the care provided and tasks completed that did not previously exist.

Additionally, the work management system disclosed provides an easy-to-use and intuitive means of scheduling a care plan via a calendar interface. Today, care plans and task scheduling are typically managed via paper care journals for in-home care agencies. When care plans are managed electronically, they are often managed with highly-detailed form templates that lack the dimension of scheduling of specific tasks at specific times. When a calendar is used, no greater granularity than a work shift is provided; the present solutions lack task-specific granularity as disclosed with regards to the present invention.

The task input calendar interface disclosed provides very critical improvements to these systems by providing a robust, highly flexible means of scheduling very detailed care plans with associated times for each task. Because of this critical enabling feature, it follows that the individual tasks can be output to a mobile tablet, a Internet connectable computer, and/or telephony services as described, and the status of tasks can also be updated via these channels. As such, it provides unprecedented visibility to the point-of care enables new and beneficial features including but not limited to alerts if tasks that have been scheduled as part of the care plan are missed.

As discussed herein, the embodiments may involve a number of functions to be performed by a computer processor, such as a microprocessor. The microprocessor may be a specialized or dedicated microprocessor that is configured to perform particular tasks according to the embodiments described herein, by executing machine-readable software code that defines the particular tasks embodied by the embodiments and examples described herein. The microprocessor may also be configured to operate and communicate with other devices such as direct memory access modules, memory storage devices, Internet-related hardware, and other devices that relate to the transmission of data in accordance with the embodiments and examples described herein. The software code may be configured using software formats such as Java, C++, XML (Extensible Mark-up Language) and other languages that may be used to define functions that relate to operations of devices required to carry out the functional operations related to the embodiments and examples described herein. The code may be written in different forms and styles, many of which are known to those skilled in the art. Different code formats, code configurations, styles and forms of software programs and other means of configuring code to define the operations of a microprocessor in accordance with the embodiments and examples described herein will not depart from the spirit and scope of the embodiments and examples described herein.

Within the different types of devices, such as laptop or desktop computers, hand held devices with processors or processing logic, and also possibly computer servers or other devices that utilize the embodiments and examples described herein, there exist different types of memory devices for storing and retrieving information while performing functions according to the embodiments and examples described herein. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the embodiments and examples described herein when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the embodiments and examples described herein as described herein enable the physical transformation of these memory devices. Accordingly, the embodiments and examples described herein as described herein is directed to novel and useful systems and methods that, in one or more embodiments, are able to transform the memory device into a different state. The embodiments and examples described herein is not limited to any particular type of memory device, or any commonly used protocol for storing and retrieving information to and from these memory devices, respectively.

Embodiments of the systems and methods described herein facilitate the management of home care provider scheduling. Additionally, some embodiments may be used in conjunction with one or more conventional data management systems and methods, or conventional virtualized systems. For example, one embodiment may be used as an improvement of existing data management systems.

Although the components, functional units, and modules illustrated herein are shown and described in a particular arrangement, the arrangement of components and modules may be altered to process data in a different manner or characterized using different technical terms or jargon by those skilled in the art. In other embodiments, one or more additional components or modules may be added to the described systems, and one or more components or modules may be removed from the described systems. Alternate embodiments may combine two or more of the described components or modules into a single component or module.

Finally, although specific embodiments and examples of the invention have been described and illustrated, the invention is not to be limited to the specific forms or arrangements of parts so described and illustrated. The scope of the invention is to be defined by the claims appended hereto and their equivalents, and also claims presented in the future and their equivalents.

What is claimed is:

1. A computer implemented method for managing tasks in a work management system comprising:
providing a digital calendar system configured to receive calendar entries;
receiving data to establish non-event tasks for use in the digital calendar; and
receiving status updates to the non-event task.

2. A method according to claim 1, further comprising receiving a status indicator associated with a particular task.

3. A method according to claim 2, wherein the status indicator is in the form of a check list entry from a user.

4. A method according to claim 2, wherein the status indicator includes a status code that relates to predetermined status definitions.

5. A method according to claim 2, wherein the status indicator includes comments from a user related to the status of the task.

6. A method according to claim 1, further comprising receiving status indicators associated with particular tasks.

7. A method according to claim 1, wherein the non-event tasks include recurring events, the method further comprising receiving a status indicator associated with a particular task.

8. A method according to claim 1, wherein the non-event tasks include recurring and non-recurring tasks, the method further comprising receiving a status indicator associated with a particular task.

9. A method according to claim 1, wherein the non-event tasks include recurring tasks that are scheduled according to one of date, time, number of days, month, and week; the method further comprising receiving a status indicator associated with a particular task.

10. A method according to claim 9, further comprising receiving user input to set the status of a task.

11. A method according to claim 9, further comprising receiving user input to reschedule and set the status of a task.

12. A method according to claim 9, further comprising receiving user input to reschedule and to perform one of setting, removing, modifying, renew, copy and configure the status of a task.

13. A method according to claim 1, further comprising receiving telephony updates to the task related data used in the digital calendar.

14. A method according to claim 1, further comprising receiving updates to the task related data used in the digital calendar from a web-based portal of a work management system.

15. A method according to claim 1, further comprising receiving a status indicator calendar entry that is associated with a particular task and that is copied from another calendar entry.

16. A method according to claim 15, wherein the status entry is an instance in the work management system that includes a checklist that is copied from another instance of a status in the work management system.

17. A method according to claim 15, wherein the status entry is an instance in the work management system associated with a scheduled item that includes a checklist that is copied from another instance of a status in the work management system.
